(19) United States
(12) Patent Application Publication
(10) Pub. No.: US 2024/0103304 A1
(43) Pub. Date: Mar. 28, 2024

(54) VERTICAL PN JUNCTION PHOTONICS MODULATORS WITH BACKSIDE CONTACTS AND LOW TEMPERATURE OPERATION

(71) Applicant: Intel Corporation, Santa Clara, CA (US)

(72) Inventors: Sagar SUTHRAM, Portland, OR (US); John HECK, Berkeley, CA (US); Ling LIAO, Fremont, CA (US); Mengyuan HUANG, Cupertino, CA (US); Wilfred GOMES, Portland, OR (US); Pushkar RANADE, San Jose, CA (US); Abhishek Anil SHARMA, Portland, OR (US)

(21) Appl. No.: 17/954,286

(22) Filed: Sep. 27, 2022

(51) Int. Cl. G02F 1/025

(52) U.S. Cl. CPC G02F 1/025

(57) ABSTRACT

Embodiments disclosed herein include a photonics module and methods of forming photonics modules. In an embodiment, the photonics module comprises a waveguide, and a modulator adjacent to the waveguide. In an embodiment, the modulator comprises a PN junction with a P-doped region and an N-doped region, where the PN junction is vertically oriented so that the P-doped region is over the N-doped region.

### TECHNICAL FIELD

Embodiments of the disclosure are in the field of semiconductor structures and processing and, in particular, to photonics modulators with backside contacts.

### BACKGROUND

For the past several decades, the scaling of features in integrated circuits has been a driving force behind an ever-growing semiconductor industry. Scaling to smaller and smaller features enables increased densities of functional units on the limited real estate of semiconductor chips. For example, shrinking transistor size allows for the incorporation of an increased number of memory or logic devices on a chip, lending to the fabrication of products with increased capacity. The drive for ever-more capacity, however, is not without issue. The necessity to optimize the performance of each device becomes increasingly significant.

Variability in conventional and currently known fabrication processes may limit the possibility to further extend them into the 10 nanometer node or sub-10 nanometer node range. Consequently, fabrication of the functional components needed for future technology nodes may require the introduction of new methodologies or the integration of new technologies in current fabrication processes or in place of current fabrication processes.

In the manufacture of integrated circuit devices, multi-gate transistors, such as tri-gate transistors and gate-all-around (GAA) transistors, have become more prevalent as device dimensions continue to scale down. Tri-gate transistors and GAA transistors are generally fabricated on either bulk silicon substrates or silicon-on-insulator substrates. In some instances, bulk silicon substrates are preferred due to their lower cost and compatibility with the existing high-yielding bulk silicon substrate infrastructure.

Scaling multi-gate transistors has not been without consequence, however. As the dimensions of these fundamental building blocks of microelectronic circuitry are reduced and as the sheer number of fundamental building blocks fabricated in a given region is increased, the constraints on the semiconductor processes used to fabricate these building blocks have become overwhelming.

### BRIEF DESCRIPTION OF THE DRAWINGS

FIG. 1 is a cross-sectional illustration of a photonics module with a vertically oriented modulator, in accordance with an embodiment.

FIG. 2A is a cross-sectional illustration of a photonics module at a stage of manufacture after a fin and a waveguide are patterned into a substrate, in accordance with an embodiment.

FIG. 2B is a cross-sectional illustration of the photonics module after a cladding is provided around the fin and the waveguide, in accordance with an embodiment.

FIG. 2C is a cross-sectional illustration of the photonics module after a modulator is formed in the fin, in accordance with an embodiment.

FIG. 2D is a cross-sectional illustration of the photonics module after a layer is provided around the waveguide and the modulator, in accordance with an embodiment.

FIG. 2E is a cross-sectional illustration of the photonics module after a first interconnect to the modulator is formed, in accordance with an embodiment.

FIG. 2F is a cross-sectional illustration of the photonics module after a carrier is attached to the layer opposite from the substrate, in accordance with an embodiment.

FIG. 2G is a cross-sectional illustration of the photonics module after the substrate is removed, in accordance with an embodiment.

FIG. 2H is a cross-sectional illustration of the photonics module after a second interconnect to the modulator is formed, in accordance with an embodiment.

FIG. 2I is a cross-sectional illustration of the photonics module after the carrier is removed, in accordance with an embodiment.

FIG. 3 illustrates a computing device in accordance with one implementation of an embodiment of the disclosure.

FIG. 4 illustrates an interposer that includes one or more embodiments of the disclosure.

### DESCRIPTION OF THE EMBODIMENTS

Embodiments described herein comprise photonics modulators with backside contacts and methods of forming such interconnects and vias. In the following description, numerous specific details are set forth, such as specific integration and material regimes, in order to provide a thorough understanding of embodiments of the present disclosure. It will be apparent to one skilled in the art that embodiments of the present disclosure may be practiced without these specific details. In other instances, well-known features, such as integrated circuit design layouts, are not described in detail in order to not unnecessarily obscure embodiments of the present disclosure. Furthermore, it is to be appreciated that the various embodiments shown in the Figures are illustrative representations and are not necessarily drawn to scale.

Certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

Embodiments described herein may be directed to front-end-of-line (FEOL) semiconductor processing and structures. FEOL is the first portion of integrated circuit (IC) fabrication where the individual devices (e.g., transistors, capacitors, resistors, etc.) are patterned in the semiconductor substrate or layer. FEOL generally covers everything up to (but not including) the deposition of metal interconnect layers. Following the last FEOL operation, the result is typically a wafer with isolated transistors (e.g., without any wires).

Embodiments described herein may be directed to back-end-of-line (BEOL) semiconductor processing and structures. BEOL is the second portion of IC fabrication where the individual devices (e.g., transistors, capacitors, resistors, etc.) are interconnected with wiring on the wafer, e.g., the metallization layer or layers. BEOL includes contacts, insulating layers (dielectrics), metal levels, and bonding sites for chip-to-package connections. In the BEOL part of the fabrication stage contacts (pads), interconnect wires, vias and dielectric structures are formed. For modern IC processes, more than 10 metal layers may be added in the BEOL.

Embodiments described below may be applicable to FEOL processing and structures, BEOL processing and structures, or both FEOL and BEOL processing and structures. In particular, although an exemplary processing scheme may be illustrated using a FEOL processing scenario, such approaches may also be applicable to BEOL processing. Likewise, although an exemplary processing scheme may be illustrated using a BEOL processing scenario, such approaches may also be applicable to FEOL processing.

In order to provide context, PN junctions are used as modulators in optoelectric systems. Typically, the PN junctions are formed over a semiconductor substrate in a planar configuration. That is, the P-doped region is laterally adjacent to the N-doped region. This is necessary since electrical contacts need to be made to both the N-doped region and the P-doped region. The lateral arrangement of the PN junction takes up more real estate on the substrate and is, therefore, undesirable.

Accordingly, embodiments disclosed herein include PN junctions for the modulators that are vertically oriented. That is, the N-doped region may be positioned above (or below) the P-doped region. The vertical arrangement is enabled through the use of dual sided processing. This allows for contacts to be made on both the top surface and the bottom surface of the PN junction. A vertical configuration for the modulator also saves valuable real estate on the substrate. Additionally, some embodiments disclosed herein may improve electrical performance of the system since resistance to the PN junction can be reduced. More particularly, the vertical modulator enables lower contact resistance to the P-doped region and the N-doped region, as opposed to lateral or ribbed structures.

In some embodiments, the PN junction is formed adjacent to an optical waveguide. The optical waveguide may be fabricated from a silicon substrate. The waveguide may also include a cladding that surrounds an entire perimeter of the waveguide. The cladding is provided over all surfaces since a dual sided processing solution is used. In an embodiment, the cladding material may also be provided over one or more surfaces of the modulator.

In an embodiment, the PN junction of the modulator may include any suitable semiconductor material. In a particular embodiment, the PN junction may comprise doped silicon. In other embodiments, other semiconductor materials may be grown (e.g., with epitaxial growth) to enhance the PN junction modulator efficiency. For example, the PN junction may comprise SiGe, Ge, or Group III-V semiconductor materials.

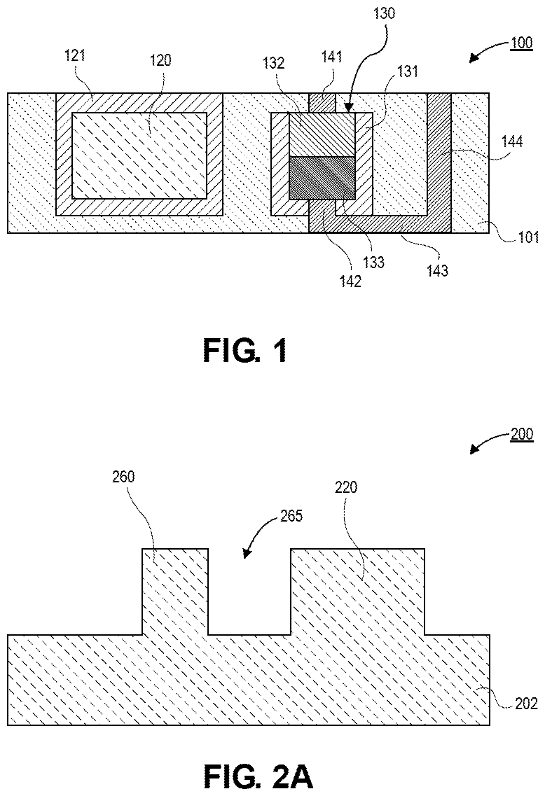

Referring now to FIG. 1, a cross-sectional illustration of a photonics module 100 is shown, in accordance with an embodiment. In an embodiment, the photonics module 100 may comprise a substrate 101. The substrate 101 may be an oxide (e.g., silicon oxide) or another insulating material. Photonics structures may be embedded in the substrate 101. For example, a waveguide 120 may be provided adjacent to a modulator 130. The waveguide 120 and the modulator 130 may be formed from semiconductor material. For example, the waveguide 120 may comprise silicon, and the modulator 130 may also comprise silicon. In other embodiments, the modulator 130 may include other semiconductor materials (e.g., SiGe, Ge, or Group III-V semiconductors) in order to improve efficiency of the modulator 130.

The modulator 130 may comprise a P-doped region 133 and an N-doped region 132 in order to form a PN junction. The P-doped region 133 may be provided below the N-doped region 132. In other embodiments, the P-doped region 133 may be provided over the N-doped region 132. The vertical orientation of the PN junction enables space savings on the surface of the substrate 101. The vertical orientation of the PN junction is enabled by the use of dual sided processing, as will be described in greater detail below. In an embodiment, the dual sided processing allows for a first contact 141 to contact the N-doped region 132 and a second contact 142 to contact the P-doped region 133. Additionally, a trace 143 and a via 144 provide electrical coupling from the second contact 142 up to the top surface of the substrate 101. As such, both the N-doped region 132 and the P-doped region 133 can be accessed from the same surface of the substrate 101 (e.g., the top surface of the substrate 101 in FIG. 1).

In an embodiment, the waveguide 120 may be surrounded by a cladding 121. The cladding 121 may be provided around an entire perimeter of the waveguide 120. In some embodiments, a surface of the cladding 121 may be substantially coplanar with a surface of the substrate 101. For example, in FIG. 1, the topmost surface of the cladding 121 is substantially coplanar with a top surface of the substrate 101. The cladding 121 may be any suitable cladding material for optical waveguides. For example, the cladding 121 may comprise a nitride (e.g., silicon nitride), an oxide (e.g., silicon oxide) or the like. In an embodiment, a cladding 131 may be provided around portions of the modulator 130. For example, the cladding 131 may be provided over three of the four surfaces of the modulator 130. The top surface of the modulator 130 may be without the cladding 131 in some embodiments. However, a cladding 131 may be provided over an entire perimeter of the modulator 130 in some embodiments. The cladding 131 may be the same material as the cladding 121 in some embodiments.

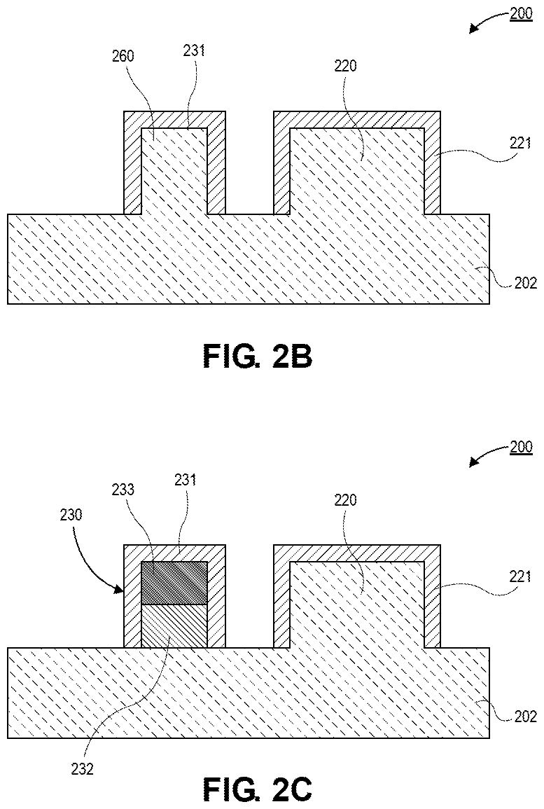

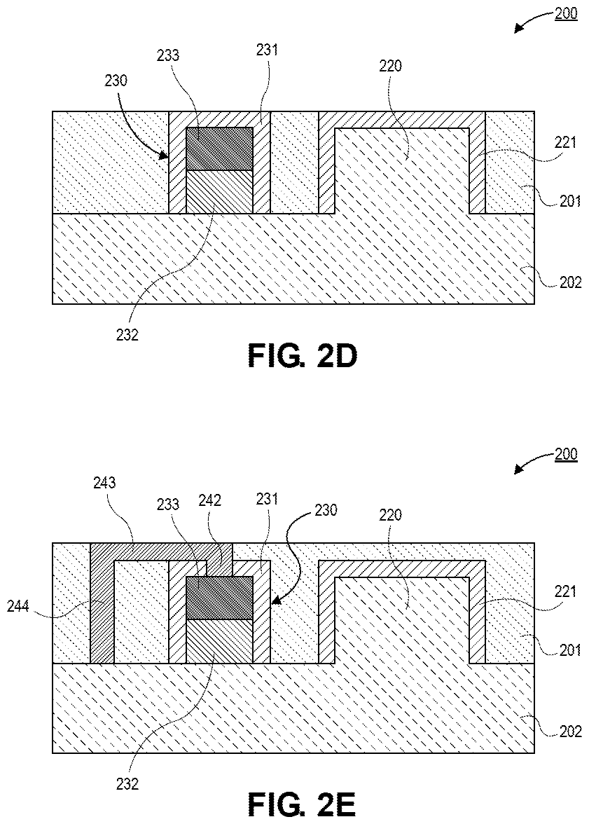

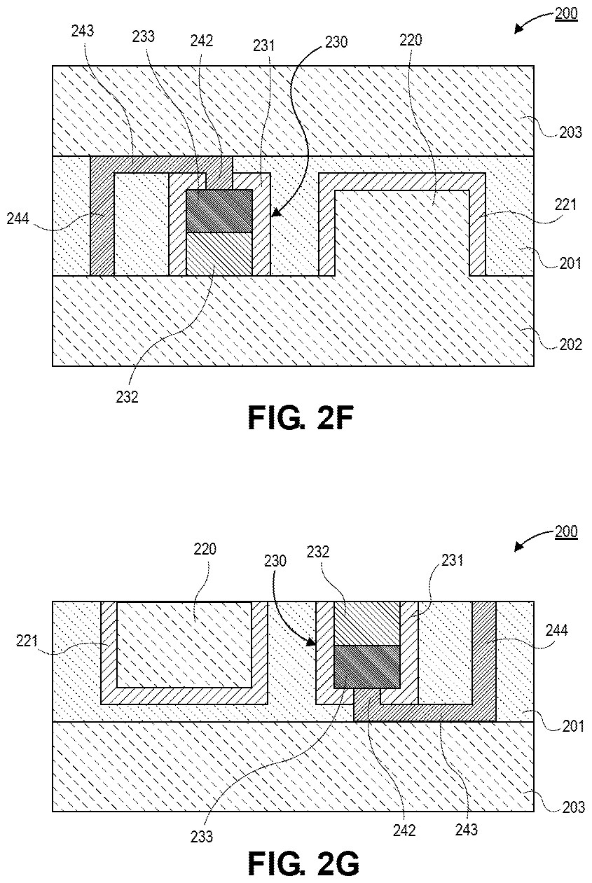

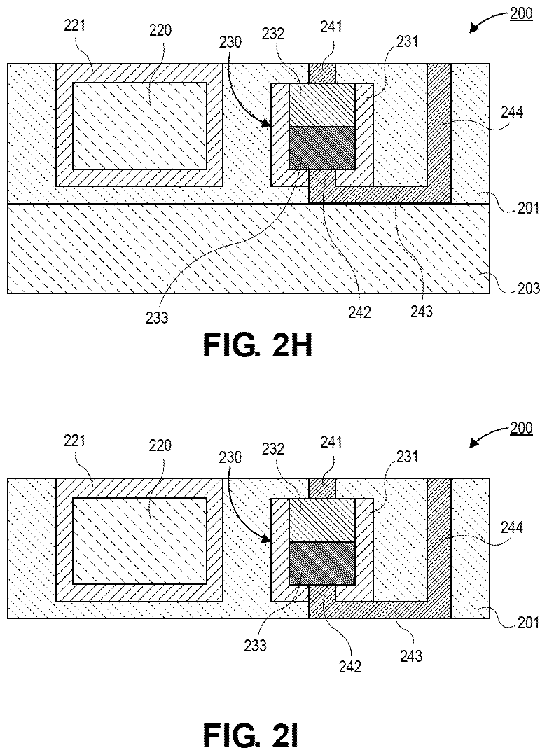

Referring now to FIGS. 2A-2I, a series of cross-sectional illustrations depicting a process for forming a photonics module 200 is shown, in accordance with an embodiment. In an embodiment, the process includes a dual sided processing operation that enables a vertical orientation of the PN junction modulator 230 adjacent to a waveguide 220.

Referring now to FIG. 2A, a cross-sectional illustration of a photonics module 200 at a stage of manufacture is shown, in accordance with an embodiment. In an embodiment, the photonics module 200 comprises a substrate 202. The substrate 202 may be a semiconductor substrate, such as silicon or the like. In an embodiment, a waveguide 220 is patterned into the substrate 202. The waveguide 220 may be a fin that extends into and out of the plane of FIG. 2A. Additionally, the patterning process may be used to form a fin 260. The fin 260 may also extend into and out of the plane of FIG. 2A. The fin 260 may have a height that is substantially equal to a height of the waveguide 220. That is, the fin 260 and the waveguide 220 may be formed with a single etching process that forms trenches 265 between the fin 260 and the waveguide 220. In other embodiments, the fin 260 or portions of the fin 260 may be epitaxially grown. In such embodiments, the fin 260 may comprise semiconductor material that is different than the semiconductor material of the substrate 202. For example, the fin 260 may comprise one or more of silicon germanium, germanium, and Group III-V semiconductor materials.

Referring now to FIG. 2B, a cross-sectional illustration of photonics module 200 after claddings 221 and 231 are formed is shown, in accordance with an embodiment. In an embodiment, the claddings 221 and 231 may comprise the same material. For example, the claddings 221 and 231 may comprise silicon oxide, silicon nitride, or any other material suitable for cladding in an optical waveguide. In an embodiment, the cladding 221 may be provided over sidewall surfaces and a top surface of the waveguide 220. Similarly, cladding 231 may be provided over sidewall surfaces and a top surface of the fin 260.

Referring now to FIG. 2C, a cross-sectional illustration of the photonics module 200 after a modulator 230 is formed in the fin 260 is shown, in accordance with an embodiment. In an embodiment, the modulator 230 may comprise a P-doped region 233 and an N-doped region 232. The P-doped region 233 and the N-doped region 232 may be doped with an ion implantation process or the like. Additionally, while shown as being formed after formation of the cladding layer 231, the doping to form the modulator 230 may occur before the cladding layer 231 is formed.

In an embodiment, the P-doped region 233 and the N-doped region 232 are vertically stacked. The vertical stacking of the P-doped region 233 and the N-doped region 232 reduces the footprint of the modulator 230 on the surface of the substrate 202. In the illustrated embodiment, the P-doped region 233 is on top of the N-doped region 232. However, it is to be appreciated that the P-doped region 233 may optionally be provided below the N-doped region 232 in some embodiments.

Referring now to FIG. 2D, a cross-sectional illustration of the photonics module 200 after a layer 201 is provided around the modulator 230 and the waveguide 220 is shown, in accordance with an embodiment. In an embodiment, the layer 201 may be an insulating material. For example, the layer 201 may comprise a silicon oxide or the like. The layer 201 may have a thickness that is greater than a height of the waveguide 220 and/or the modulator 230. In a particular embodiment, the thickness of the layer 201 is substantially equal to a height of the waveguide 220 plus a thickness of the cladding 221. That is, a top surface of the cladding 221 may be substantially coplanar with a top surface of the layer 201.

Referring now to FIG. 2E, a cross-sectional illustration of the photonics module 200 after a first interconnect 242 is made to the P-doped region 233 is shown, in accordance with an embodiment. In an embodiment, the first interconnect 242 may pass through the cladding 231 in order to contact the P-doped region 233. A trace 243 may extend out laterally from the first interconnect 242. A via 244 through the layer 201 may be provided at an end of the trace 243 opposite from the first interconnect 242. The trace 243 and the via 244 enable an electrical connection to a surface of the layer 201 opposite from the top surface of the P-doped region 233.

Referring now to FIG. 2F, a cross-sectional illustration of the photonics module 200 after a carrier 203 is attached to the layer 201 is shown, in accordance with an embodiment. The carrier 203 may be any suitable material for supporting the layer 201. For example, the carrier 203 may be silicon, glass, or the like. The carrier 203 is applied over the layer 201 opposite from the substrate 202. While shown as the same shading in FIG. 2F, it is to be appreciated that the carrier 203 may be a different material than the substrate 202. In an embodiment, the carrier 203 may be bonded to the layer 201 with any suitable bonding architecture. In some embodiments, an adhesion layer (not shown) may be provided between the layer 201 and the carrier 203 in order to secure the two together.

Referring now to FIG. 2G, a cross-sectional illustration of the photonics module 200 after the photonics module is flipped upside down and the substrate 202 is removed is shown, in accordance with an embodiment. In an embodiment, the substrate 202 may be removed with a polishing or grinding process (e.g., chemical mechanical polishing (CMP) or the like). Removal of the substrate 202 allows for surfaces of the waveguide 220 and the modulator 230 to be exposed. In the case of the modulator 230, the N-doped region 232 may be exposed. The via 244 may also be exposed by the removal of the substrate 202. As such, the P-doped region 233 may be electrically coupled to the exposed surface of the layer 201 through the first interconnect 242, the traces 243, and the via 244.

Referring now to FIG. 2H, a cross-sectional illustration of the photonics module 200 after a second interconnect 241 is connected to the N-doped region 232 is shown, in accordance with an embodiment. In an embodiment, the layer 201 may first be extended in order to cover the top surface of the N-doped region 232. The second interconnect 241 may pass through the layer 201 to reach the N-doped region 232. As shown, both the N-doped region 232 and the P-doped region 233 are electrically coupled to the top surface of the layer 201. This is enabled by the dual sided processing described herein. Additionally, a cladding 221 may be provided over the exposed surface of the waveguide 220. As such, there is cladding 221 surrounding an entire perimeter of the waveguide 220. In an embodiment, the top surface of the cladding 221 may be substantially coplanar with a top surface of the layer 201.

Referring now to FIG. 2I, a cross-sectional illustration of the photonics module 200 after the carrier 203 is removed is shown, in accordance with an embodiment. In an embodiment, the carrier 203 may be removed by deactivating an adhesion layer (not shown). In other embodiments, a polishing or etching process may be used to remove the carrier 203. After the carrier 203 is removed, a top surface and a bottom surface of the layer 201 are exposed. The layer 201 embeds both the waveguide 220 and the modulator 230.

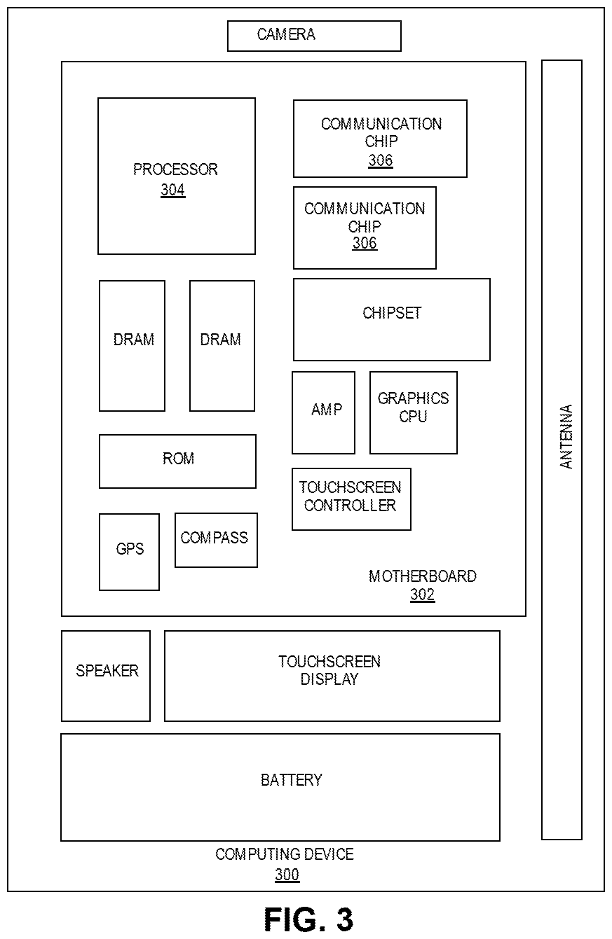

FIG. 3 illustrates a computing device 300 in accordance with one implementation of an embodiment of the present disclosure. The computing device 300 houses a board 302. The board 302 may include a number of components, including but not limited to a processor 304 and at least one communication chip 306. The processor 304 is physically and electrically coupled to the board 302. In some implementations the at least one communication chip 306 is also physically and electrically coupled to the board 302. In further implementations, the communication chip 306 is part of the processor 304.

Depending on its applications, computing device 300 may include other components that may or may not be physically and electrically coupled to the board 302. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 306 enables wireless communications for the transfer of data to and from the computing device 300. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 306 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 300 may include a plurality of communication chips 306. For instance, a first communication chip 306 may be dedicated to shorter range wireless communications such as Wi-Fi and Bluetooth and a second communication chip 306 may be dedicated to longer range wireless communications such as GPS, EDGE, GPRS, CDMA, WiMAX, LTE, Ev-DO, and others.

The processor 304 of the computing device 300 includes an integrated circuit die packaged within the processor 304. The integrated circuit die of the processor 304 may include one or more structures, such as a photonics module that comprises a waveguide and a vertically oriented modulator, built in accordance with implementations of embodiments of the present disclosure. The term “processor” may refer to any device or portion of a device that processes electronic data from registers and/or memory to transform that electronic data into other electronic data that may be stored in registers and/or memory.

The communication chip 306 also includes an integrated circuit die packaged within the communication chip 306. The integrated circuit die of the communication chip 306 may include one or more structures, such as a photonics module that comprises a waveguide and a vertically oriented modulator, built in accordance with implementations of embodiments of the present disclosure.

In further implementations, another component housed within the computing device 300 may contain an integrated circuit die that includes one or structures, such as a photonics module that comprises a waveguide and a vertically oriented modulator, built in accordance with implementations of embodiments of the present disclosure.

In various implementations, the computing device 300 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 300 may be any other electronic device that processes data.

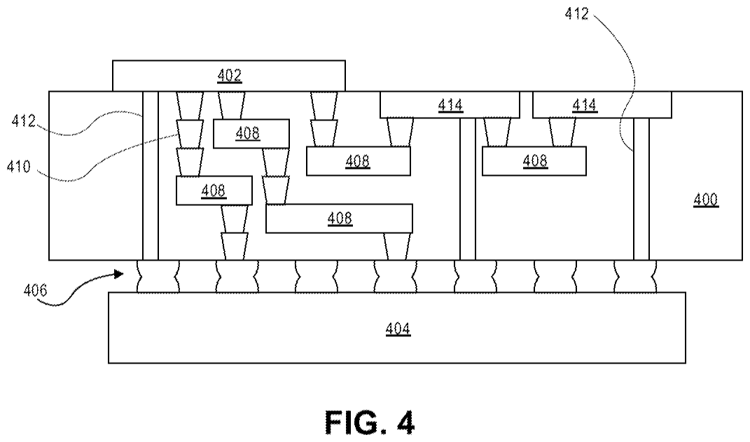

FIG. 4 illustrates an interposer 400 that includes one or more embodiments of the present disclosure. The interposer 400 is an intervening substrate used to bridge a first substrate 402 to a second substrate 404. The first substrate 402 may be, for instance, an integrated circuit die. The second substrate 404 may be, for instance, a memory module, a computer motherboard, or another integrated circuit die. Generally, the purpose of an interposer 400 is to spread a connection to a wider pitch or to reroute a connection to a different connection. For example, an interposer 400 may couple an integrated circuit die to a ball grid array (BGA) 406 that can subsequently be coupled to the second substrate 404. In some embodiments, the first and second substrates 402/404 are attached to opposing sides of the interposer 400. In other embodiments, the first and second substrates 402/404 are attached to the same side of the interposer 400. And in further embodiments, three or more substrates are interconnected by way of the interposer 400.

The interposer 400 may be formed of an epoxy resin, a fiberglass-reinforced epoxy resin, a ceramic material, or a polymer material such as polyimide. In further implementations, the interposer 400 may be formed of alternate rigid or flexible materials that may include the same materials described above for use in a semiconductor substrate, such as silicon, germanium, and other group III-V and group IV materials.

The interposer 400 may include metal interconnects 408 and vias 410, including but not limited to through-silicon vias (TSVs) 412. The interposer 400 may further include embedded devices 414, including both passive and active devices. Such devices include, but are not limited to, capacitors, decoupling capacitors, resistors, inductors, fuses, diodes, transformers, sensors, and electrostatic discharge (ESD) devices. More complex devices such as radio-frequency (RF) devices, power amplifiers, power management devices, antennas, arrays, sensors, and MEMS devices may also be formed on the interposer 400. In accordance with embodiments of the disclosure, apparatuses or processes disclosed herein may be used in the fabrication of interposer 400 or in the fabrication of components included in the interposer 400.

Thus, embodiments of the present disclosure include integrated circuit structures having a photonics module that comprises a waveguide and a vertically oriented modulator, and methods of fabricating photonics modules that comprise a waveguide and a vertically oriented modulator.

The above description of illustrated implementations of embodiments of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

Example 1: a photonics module, comprising: a waveguide; and a modulator adjacent to the waveguide, wherein the modulator comprises: a PN junction with a P-doped region and an N-doped region, wherein the PN junction is vertically oriented so that the P-doped region is over the N-doped region.

Example 2: the photonics module of Example 1, wherein the waveguide is surrounded on four sides by a cladding.

Example 3: the photonics module of Example 1 or Example 2, wherein the PN junction is surrounded by a cladding on three sides.

Example 4: the photonics module of Examples 1-3, wherein the waveguide and the modulator comprise silicon.

Example 5: the photonics module of Examples 1-4, wherein the waveguide comprises a first semiconductor and the modulator comprises a second semiconductor that is different than the first semiconductor.

Example 6: the photonics module of Example 5, wherein the first semiconductor comprises silicon.

Example 7: the photonics module of Example 5 or Example 6, wherein the second semiconductor comprises silicon and germanium.

Example 8: the photonics module of Example 5 or Example 6, wherein the second semiconductor comprises a Group III-V semiconductor.

Example 9: the photonics module of Examples 1-8, wherein a first electrical contact is provided on the P-doped region and a second electrical contact is provided on the N-doped region.

Example 10: the photonics module of Example 9, wherein the first electrical contact and the second electrical contact are exposed on the same surface of the photonics module.

Example 11: the photonics module of Examples 1-10, wherein the waveguide and the modulator are embedded in an oxide layer.

Example 12: a method of forming a photonics module, comprising: etching a semiconductor substrate to form a waveguide and a modulator; forming a cladding around the waveguide and the modulator; doping the modulator to have a P-type region and an N-type region to form a PN junction, wherein the P-type region is over the N-type region; forming an insulator around the waveguide and the modulator; forming a first contact to the P-type region, wherein the first contact includes a via through the insulator; attaching a carrier to the insulator; removing the semiconductor substrate; forming a second contact to the N-type region; and releasing the carrier.

Example 13: the method of Example 12, wherein the waveguide is entirely surrounded by the cladding.

Example 14: the method of Example 12 or Example 13, wherein the first contact and the second contact are exposed at the same side of the insulator.

Example 15: the method of Examples 12-14, wherein the waveguide comprises silicon.

Example 16: the method of Examples 12-15, wherein the modulator comprises silicon and germanium, or germanium, or a Group III-V semiconductor.

Example 17: the method of Examples 12-16, wherein the N-type region is covered on two sides by the cladding.

Example 18: a computing system, comprising: a board; an optoelectric system coupled to the board, wherein the optoelectric system comprises: a waveguide; a modulator with a P-type region and an N-type region, wherein the N-type region is provided over the P-type region in a vertical orientation; a first contact to the N-type region; and a second contact to the P-type region, wherein the second contact wraps around an edge of the modulator.

Example 19: the computing system of Example 18, further comprising: a memory coupled to the board.

Example 20: the computing system of Example 18 or Example 19, further comprising: a communication chip coupled to the board.

What is claimed is:

1. A photonics module, comprising:
a waveguide; and
a modulator adjacent to the waveguide, wherein the modulator comprises:
a PN junction with a P-doped region and an N-doped region, wherein the PN junction is vertically oriented so that the P-doped region is over the N-doped region.

2. The photonics module of claim 1, wherein the waveguide is surrounded on four sides by a cladding.

3. The photonics module of claim 1, wherein the PN junction is surrounded by a cladding on three sides.

4. The photonics module of claim 1, wherein the waveguide and the modulator comprise silicon.

5. The photonics module of claim 1, wherein the waveguide comprises a first semiconductor and the modulator comprises a second semiconductor that is different than the first semiconductor.

6. The photonics module of claim 5, wherein the first semiconductor comprises silicon.

7. The photonics module of claim 5, wherein the second semiconductor comprises silicon and germanium.

8. The photonics module of claim 5, wherein the second semiconductor comprises a Group III-V semiconductor.

9. The photonics module of claim 1, wherein a first electrical contact is provided on the P-doped region and a second electrical contact is provided on the N-doped region.

10. The photonics module of claim 9, wherein the first electrical contact and the second electrical contact are exposed on the same surface of the photonics module.

11. The photonics module of claim 1, wherein the waveguide and the modulator are embedded in an oxide layer.

12. A method of forming a photonics module, comprising:
etching a semiconductor substrate to form a waveguide and a modulator;
forming a cladding around the waveguide and the modulator;
doping the modulator to have a P-type region and an N-type region to form a PN junction, wherein the P-type region is over the N-type region;
forming an insulator around the waveguide and the modulator;
forming a first contact to the P-type region, wherein the first contact includes a via through the insulator;
attaching a carrier to the insulator;
removing the semiconductor substrate;
forming a second contact to the N-type region; and
releasing the carrier.

13. The method of claim 12, wherein the waveguide is entirely surrounded by the cladding.

14. The method of claim 12, wherein the first contact and the second contact are exposed at the same side of the insulator.

15. The method of claim 12, wherein the waveguide comprises silicon.

16. The method of claim 12, wherein the modulator comprises silicon and germanium, or germanium, or a Group III-V semiconductor.

17. The method of claim 12, wherein the N-type region is covered on two sides by the cladding.

18. A computing system, comprising:
a board;
an optoelectric system coupled to the board, wherein the optoelectric system comprises:
a waveguide;
a modulator with a P-type region and an N-type region, wherein the N-type region is provided over the P-type region in a vertical orientation;
a first contact to the N-type region; and
a second contact to the P-type region, wherein the second contact wraps around an edge of the modulator.

19. The computing system of claim 18, further comprising:
a memory coupled to the board.

20. The computing system of claim 18, further comprising:
a communication chip coupled to the board.
